(19) United States
(12) Patent Application Publication
(10) Pub. No.: US 2025/0238780 A1
(43) Pub. Date: Jul. 24, 2025

(54) MULTI-PURPOSE INTELLIGENT PORTABLE BATTERY SYSTEM

(71) Applicant: Zed Motors Inc., Pleasant Hill, CA (US)

(72) Inventor: Oloufounmi Koucoi, Cotonou (BJ)

(21) Appl. No.: 19/030,974

(22) Filed: Jan. 17, 2025

Related U.S. Application Data
(60) Provisional application No. 63/623,187, filed on Jan. 19, 2024.

(51) Int. Cl. G06Q 20/32; G06Q 50/06; H01M 10/42

(52) U.S. Cl. CPC G06Q 20/3229; G06Q 50/06; H01M 10/425; H01M 2010/4271; H01M 2010/4278

(57) ABSTRACT

A battery system includes battery cells coupled to a battery management system (BMS), a power output port, a wireless communication module, a payment module. Engaging a locking module causes the power output port to decouple from the BMS. Disengaging the locking module causes the power output port to couple to the BMS. One or more processing devices are to determine health data and location data of the battery system based on data collected by the sensor module, and transmit the health data and the location data to an external battery management device via the wireless communication module. Responsive to determining the health data satisfies a health threshold, determine payment data using the payment module. Responsive to determining that the payment data satisfies a payment condition, disengage the locking module based on a locking scheme associated with the payment condition.

### PRIORITY CLAIM

This application claims the benefit of U.S. Provisional Application No. 63/623,187, filed Jan. 19, 2024, the entire contents of which are hereby incorporated by reference.

### TECHNICAL FIELD

Embodiments of the disclosure relate generally to energy capture devices, and more specifically to a multi-purpose intelligent portable battery.

### BACKGROUND

Batteries are relatively expensive, and can take a long time to charge. Battery swapping can help mitigate these challenges. However, the batteries used in some battery swapping solutions are often specialized, expensive, and non-standard, and the swapping mechanism itself can be cumbersome and require specialized equipment.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an environment for charging and using a battery system, in accordance with aspects of the disclosure.

FIG. 2 illustrates a battery system, in accordance with aspects of the disclosure.

FIG. 3 is a flow diagram of an example method for operating a battery system, in accordance with aspects of the disclosure.

### DETAILED DESCRIPTION

Aspects of the present disclosure are directed to a multi-purpose intelligent portable battery system.

Batteries have long been used to capture and store energy generated by solar panels or from other types of electrical power generation methods. The stored electrical power can then later be used in a more portable, consistent, or reliable form factor, such as backup power, to provide power to remote locations, or to power a means of transportation. When used to power means of transportation, batteries are capable of storing sufficient energy to power various means of transportation, however batteries cannot be charged as fast as a gas tank can be filled, which may present a challenge to battery-powered transportation users. Often, batteries can be expensive. For example, in some modern electric vehicles, the cost of the battery can be a substantial portion of the cost to produce the entire vehicle. For these and other commercial reasons, it can be highly beneficial to minimize battery loss due to misuse, inadvertent acquisition or intentional theft, etc.

Some solutions to these and related challenges can include battery swapping services that store and charge batteries. A battery with a depleted charge can be swapped for a battery that is fully charged. Some battery swapping solutions may be cumbersome and/or require special equipment or techniques, and thus may often be performed by a service center. Some battery swapping solutions are developed and available for specialized batteries or specialized uses. That is, the battery is manufactured for a specific intended use, and does not otherwise function in other settings. For example, electric vehicle battery swapping batteries can be manufactured to work with a specific type and/or model of car, due to power output, physical size limitations, or other characteristics. This can limit the utility of the battery to specialized uses. In this way, some batteries used in some battery swapping services can be designed to discourage use of the batteries for any purpose other than the specific intended use, which can reduce the likelihood that the battery swapping service will experience battery theft or accidental loss.

Aspects of the present disclosure address the above and other deficiencies by providing a multi-purpose intelligent portable battery system that is easily swappable, can operate under various electrical loads, and includes sensors to help mitigate the potential loss and/or misuse of the multi-purpose intelligent portable battery system.

In some implementations, the battery system can be sized to be handled with relative ease by many individuals, and can include connectors that facilitate easily connecting multiple battery systems together to support loads with higher power requirements (e.g., modular form factor). For example, the same battery can be adaptively used in electric mobility (“e-mobility”) products such as electric bikes (“e-bikes”), electric motorcycles (“e-motorcycles”), and golf carts, off-grid living solutions, (e.g., household appliance power needs, farming needs such as pumps, public lighting, small business power needs, etc.), and for power-sharing where once a battery is fully charged, excess power can flow to other loads. In some implementations, multiple battery systems can be connected to increase the overall power output potential. For example, larger electrical devices or home appliances such as a refrigerator may require a larger consistent power output than a single battery system can provide.

In some implementations, the battery system can include one or more power input ports and one or more power output ports for connecting the battery system to other battery systems, charging systems, and/or to power external loads. In some implementations, the battery system can include circuitry that detects power requirements for an electrical load (e.g., an e-motorcycle, a refrigerator, a lamp) and adjust the output power of the battery system accordingly. In some embodiments, the battery system includes a switch or dial or other selection mechanism that enables a user to manually select a power output of the battery (e.g., 12V, 48V, etc.). In some embodiments, the battery system includes multiple ports, each associated with a different power output. The battery system may detect a plug and/or load on one of the ports, and automatically select a power output associated with that port. In some implementations, the battery system can be charged (e.g., accept electrical power inputs) from various input sources, including using solar panels, wind power, gas-powered generator, hydropower, and/or grid power. In some implementations, the battery system can be charged by alternating current (AC) sources or direct current (DC) sources.

In some implementations, the battery system can include one or more communication input/output (I/O) ports to directly communicate with internal components of the battery system (such as the various modules and/or sensors). In some implementations, the modules and/or sensors can communicate with a battery system management service to provide health data and/or location data of each connected battery system.

In some implementations, the battery system can include a locking module that prevents the battery system from powering an external load when locked. When unlocked, the battery system can be used to power external loads. In some implementations, the locking module can be coupled to an authorization, or payment module. The payment module can accept electronic transfer payments from battery system users. Once payment has been verified, the locking module can unlock the battery system and the user can use the battery system to power an external load.

In some implementations, the battery system can include a user interaction module. The user interaction module can allow the user of the battery system to monitor the charge levels, health, and other information pertaining to the battery system. In some implementations, the user interactive module can be configured to connect to a user device through a wireless communication module of the battery system.

Advantages of the present disclosure include, but are not limited to, improved battery swapping capabilities, improved utility of the battery system, a reduction in stolen or misplaced battery systems, and a reduction in damage to battery systems. With the modular form factor and variable voltage output, the battery system is versatile and can be used in mixed applications. This can reduce the need for specialized battery systems that often only function for one predetermined purpose (e.g., one specific external load and/or voltage output). The included intelligent modules and/or sensors all for the the location and health of each battery system to be monitored and stored in real time, which can help discourage theft, or aid in recovering lost, misplaced, or stolen battery systems. The included payment modules allow users of the battery system to easily access and store electrical power, provided the payment module can verify payment from the battery system user (e.g., the payment module is connected to a payment verification system).

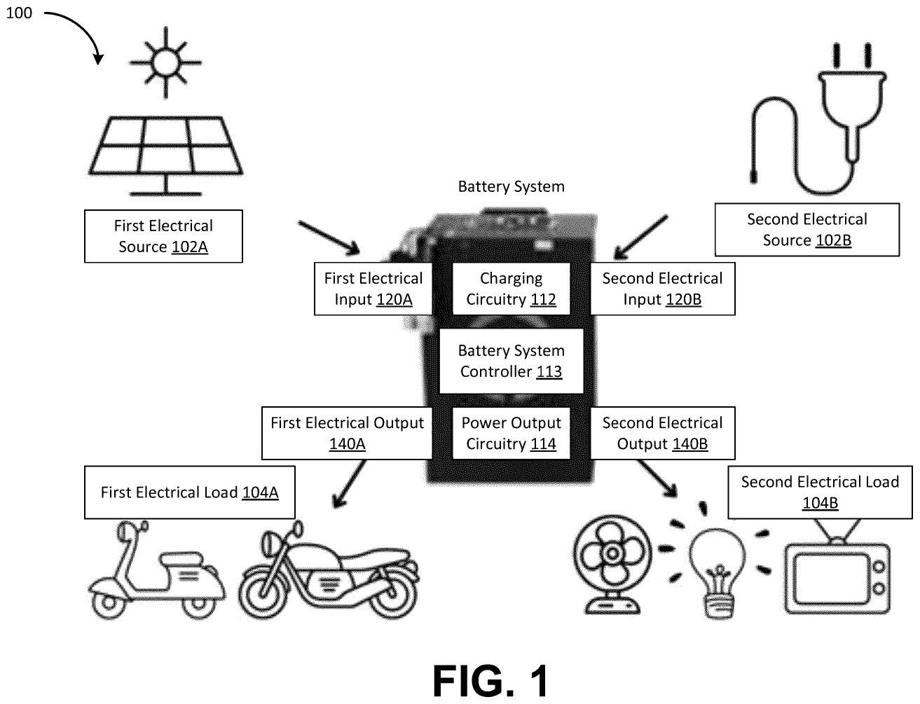

FIG. 1 illustrates an environment 100 for charging and using a battery system 101, in accordance with aspects of the disclosure. Battery system 101 can include charging circuitry 112, first electrical input 120A and second electrical input 120B (herein referred to collectively as “electrical inputs 120”) coupled to the charging circuitry 112, a battery system controller 113, power output circuitry 114, and first electrical output 140A and second electrical output 140B (herein referred to collectively as “electrical outputs 140”).

In some implementations, the battery system 101 can accept the same or similar input voltages at the first electrical input 120A and the second electrical input 120B from first electrical source 102A and second electrical source 102B (herein referred to collectively as “electrical sources 102”), respectively. In some embodiments, different voltages are accepted at first electrical input 120A and second electrical input 120B. The electrical sources 102 can include, for example, one or more of a solar power source, a wind power source, a gas-powered generator, hydropower, and/or grid power (e.g., power from an electrical grid).

In some implementations, the input voltage accepted at either of the electrical inputs 120 is configurable. For example, the electrical inputs 120 can accept a 20-volt input, a 40-volt input, a 60-volt input, 110-volt input, 220-volt input, etc. In some implementations, the battery system 101 can automatically determine the input voltage at the electrical inputs 120, and automatically adjust the charging circuitry 112 based on the determined input voltage(s). In some implementations, the charging circuitry 112 can be adjusted using the battery system controller 113. In some implementations, the charging circuitry 112 can determine the input voltage(s) at the electrical inputs 120 and self-adjust based on the determined input voltage(s). In some implementations, the charging circuitry 112 can include one or more DC-to-DC step-down converters that are controlled by a charge controller.

In some implementations, the battery system 101 includes a single electrical input 120. In some implementations, the battery system 101 can accept electrical inputs (e.g., the battery system 101 can be charged) at the first electrical input 120A and the second electrical input 120B simultaneously. In some implementations, battery system 101 can accept alternating current (AC) inputs at electrical inputs 120. In some implementations, battery system 101 can accept direct current (DC) inputs at electrical inputs 120.

In some implementations, the battery system 101 can provide the same or similar output voltages at the first electrical output 140A and the second electrical output 140B to the first electrical load 104A and the second electrical load 104B (herein referred to collectively as “electrical loads 104”) respectively. Alternatively, different output voltages may be provided at first electrical output 140A and second electrical output 140B. The electrical loads 104 can include, for example one or more e-mobility machines such as an e-motorcycle, devices such as a computer or mobile phone, and/or appliances, such as a refrigerator, etc.

In some implementations, the output voltage provided by either of the electrical outputs 140 is configurable. For example, the electrical outputs 140 can provide a 3-volt outputs, a 5-volt output, a 12-volt output, a 24-volt output, a 36-volt output, a 48-volt output, a 60-volt output, a 72-volt output, etc. In some implementations, the battery system 101 can automatically determine the output voltage at the electrical outputs 140, and automatically adjust the power output circuitry 114 based on the determined output voltage(s). In some implementations, the power output circuitry can be adjusted using the battery system controller 113. In some implementations, the power output circuitry 114 can determine the output voltage(s) at the electrical outputs 140 and self-adjust based on the determined output voltage(s).

In some implementations, the battery system 101 can include circuitry that detects power requirements for an electrical load (e.g., an e-motorcycle, a refrigerator, a lamp) and adjust the output power of the battery system 101 accordingly. For example, a battery system 101 may be removed from an e-motorcycle, and subsequently connected to an electrical device, such as a lamp, or added to a group of connected battery systems that are connected to a home appliance, such as a refrigerator.

In some implementations, the output power can be adjusted by adjusting the output voltage. For example, if a twelve volt device is connected to the battery system, the battery system can detect that the twelve volt device requires 12 volts, and accordingly output 12 volts. In another example, if a seventy-two volt device is connected to the same battery system (e.g., immediately after disconnecting the twelve volt device), the battery system can detect that the seventy-two volt device requires 72 volts, and accordingly output 72 volts. In some implementations, the power output circuitry 114 can include one or more DC-to-DC step-down converters that are controlled by a charge controller.

In some implementations, the battery system 101 includes a single electrical output 140. In some implementations, the battery system 101 can provide electrical outputs 140 (e.g., the battery system 101 can provide power) at the first electrical output 140A and the second electrical output 140B simultaneously. In some implementations, electrical outputs 140 can include ports such as such as a standard wall outlet (e.g., an International Electrotechnical Commission (IEC) Plug Type A, B, C, D, E, F, G, H, I, J, K, L, M, N, or O, respectively, or combinations of respective IEC Plug Types), a universal serial bus (USB) powered outlet, or other standardized or non-standardized power deliver ports. In some implementations, each of the one or more power output ports can operate independently. That is, one power output port can provide 72 volts to one external load, while another power output port can simultaneously provide 12 volts to another external load. In some implementations, the battery system can include one or more internal fuses that can be triggered in the event of a sudden or unexpected discharge to reduce damage to the battery system, the user of the battery system, and/or an external load. In some implementations, the one or more internal fuses can be triggered or reset remotely (e.g., using software and/or firmware).

In some implementations, the battery system controller 113 can include a battery management system (BMS). In some implementations, the battery system controller 113 can include one or more processing devices. In some implementations, the battery system controller can communicate with other components of the battery system 101, and/or facilitate communications between the components of the battery system 101.

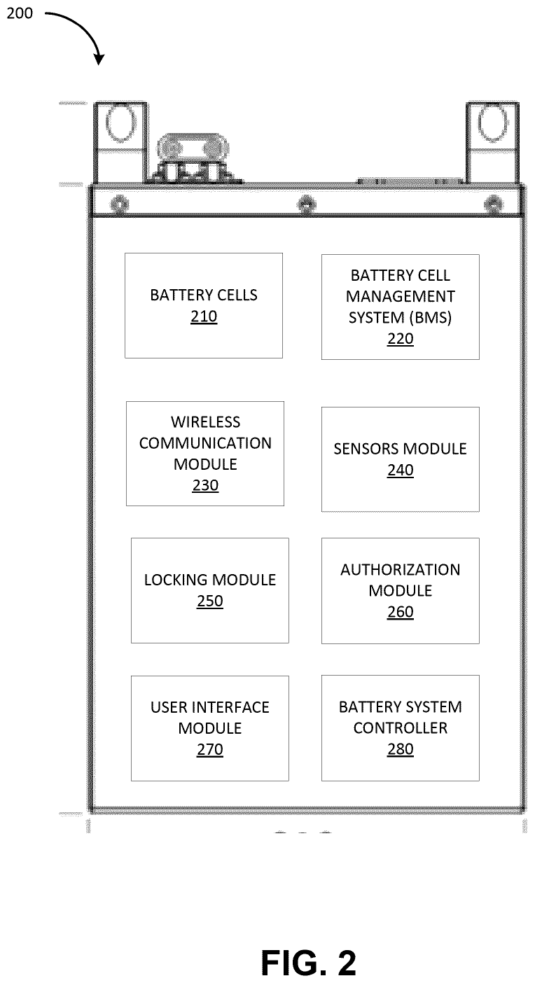

FIG. 2 illustrates a battery system 200, in accordance with aspects of the disclosure. Battery system 200 includes battery cells 210, battery cell management system (BMS) 220 (e.g., a battery management system), wireless communication module 230, sensors module 240, locking module 250, authorization module 260, user interface module 270, and battery system controller 280. In some implementations, battery system controller 280 can be the same as or similar to battery system controller 113 as described with reference to FIG. 1.

Battery cells 210 can include various battery types, such as lead-acid batteries, lithium-ion (Li-ion) batteries, nickel-iron (NiFe) batteries, sodium-sulfur (NaS) batteries, lithium iron phosphate (LiFePO₄) batteries, or other similar types of batteries capable of storing electrical charge.

Battery cell management system (BMS) 220 can be a circuit configured to balance the charge levels of individual battery cells during charging events and discharging events (e.g., when powering an external load). The BMS 220 can cause the charge levels of each battery cell 210 to remain similar to the charge levels of respectively connected battery cells 210.

Wireless communication module 230 can include transmitters, receivers, transceivers, and/or antennas for wireless communications. For example, wireless communication module 230 can include one or more of a wireless-fidelity “Wi-Fi®” module, a Bluetooth® module, or a cellular communication module. In some implementations, the wireless communication module 230 can be configured to exclusively communicate with a remote battery management device (e.g., a server). In some implementations, the wireless communication module 230 can be configured to connect with one or more personal devices (e.g., a personal computing device, mobile computing device, tablet device, etc.) of a user of the battery system 200. In some implementations, data, such as location data or battery system health data (e.g., collected by sensors module 240, described below) can be transmitted by the wireless communication module 230 in real-time.

Sensors module 240 can include various components for collecting data from the battery system 200 and/or the environment where the battery system 200 is located. For example, sensors module 240 can include location sensors/modules, such as a global positioning system (GPS) module, position sensors, such as an accelerometer or gyroscope, internal temperature sensors, external temperature sensors, pressure sensors, humidity sensors, etc. In some implementations, data captured by components of the sensor module 240 can be processed by the battery system controller. In some implementations, data captured by components of the sensor module 240 (or processed data) can be transmitted by the wireless communication module 230.

Locking module 250 can prevent the battery system 200 from powering an external load when engaged (e.g., “locked”). When disengaged, (e.g., “unlocked”), the battery system 200 can be capable of powering external loads (not illustrated). In some implementations, the locking module 250 can be used as a security module for the battery system 200. For example, a user of the battery system 200 can engage the locking module 250 (e.g., “lock” the battery system 200) to prevent unauthorized use of the battery system 200 by another person. In some implementations, once the battery system 200 has depleted to a certain charge level, but has not fully depleted, the locking module 250 can be automatically engaged. This can allow the battery system 200 to maintain a power reserve that can be used to power the various modules and/or sensors in the battery system as described herein with reference to FIG. 2. In some implementations, retaining a power reserve can also reduce the risk of damaging the battery cells 210. In some implementations, the battery system 200 can be charged while the locking module 250 is engaged (e.g., “locked”).

Authorization module 260 can be coupled to the locking module 250 and the battery system controller 280. In some implementations, the authorization module 260 can be coupled to the wireless communication module 230. In some implementations, the authorization module 260 can be a payment module. That is, the authorization module 260 can determine whether the user is authorized to use the battery system 200 based on verification of payment by the user. Once the authorization module 260 has determined the user is authorized to use the battery system 200 (e.g., by verifying payment by the user, or verifying authorization with an external battery management service or device), the locking module 250 can disengage (e.g., “unlock”) and the user can use the battery system 200 to power an external load. In some embodiments, a third-party service can authorize whether the locking mechanism 250 can be disengaged (e.g., “unlocked”). For example, and in some implementations, a third-party payment service can verify receipt of payment, and provide an indication of the receipt of payment to the battery management service. The battery management service can communicate that the locking module 250 of the battery system 200 can be disengaged (though the wireless communication module 230). In another example, and in some implementations, a third-party payment service can verify receipt of payment, and provide an indication of the receipt of payment directly to the authorization module 260 (e.g., through the wireless communication module 230). In some implementations, the authorization module 260 can include a wireless communication system, such as a cellular connection using a subscriber identify module (SIM) card. In some implementations, the authorization module 260 can facilitate a third-party pay-by-SIM card payment service as the method of authorizing that the battery system 200 can be used by the user.

In some implementations, users of the battery system 200 can pay to use the battery system 200 as a power source. In some implementations, the battery system 200 can be charged while the locking module 250 is engaged, and used as a power source only once the locking module 250 is disengaged (e.g., the user does not pay for battery charging, instead the user pays for depleting charge from the battery system 200 to power an external load). In some implementations, payments to the authorization module 260 can be prepaid. That is, the battery system 200 can be locked until payment is received and processed by the authorization module 260. In some implementations, payments can be tied to a quantity of charge depletion (e.g., power usage) of the battery system 200. For example, in a fully charged battery system 200 that has a usable 10 kilowatt hour (kWh) capacity, a user could pay for 1 kWh. Once the charge of the battery system 200 has been depleted by 1 kWh, the battery system 200 would engage the locking module 250 to lock the battery system 200 (which would then have 9 kWh of stored power).

The user interface module 270 can provide the user of the battery system 200 with information related to charge levels, battery system health, and/or data collected from components of the sensors module 240 and/or processed by the battery system controller 280. In some implementations, the user interface module 270 can include a display. In some implementations, the display can present informational graphics of battery system charge levels, health and/or other information pertaining to the battery system 200. In some implementations, the display can present local weather information. In some implementations, the display can be touch-responsive (e.g., a touch screen) or elements on the display can be navigated through using dedicated hardware buttons.

In some implementations, the user interface module 270 can be configured to connect to a user device through a wireless communication module 230 In some implementations, the battery system information can be presented on the user device in an application or webpage developed for using and monitoring the battery system 200.

In some implementations, the user interface module 270 can facilitate payment by the user to use the battery system 200. The user interface module 270 can present the user of the battery system 200 with the information necessary to provide a payment to a third-party payment verification service. In some implementations, some, or all of the authorization module 260 can be integrated into the user interface module. In some implementations, the user interface module 270 can facilitate direct payment for use of the battery system 200 by the user.

The battery system controller 280 can manage the interactions between the various components of the battery system 200 (e.g., BMS 220, wireless communication module 230, sensors module 240, locking module 250, authorization module 260, and user interface module 270). In some implementations, the battery system controller 280 can be electrically coupled to one or more physical communication input/output (I/O) ports of the battery system 200 (not illustrated). In some implementations, the battery system controller 280 can collect data from components of the battery system 200, and facilitate communication with a battery system management service (not illustrated). In some implementations, the battery system controller 280 can process data collected at any of the components of the battery system 200, and provide the unprocessed or processed data to other components of the battery system 200.

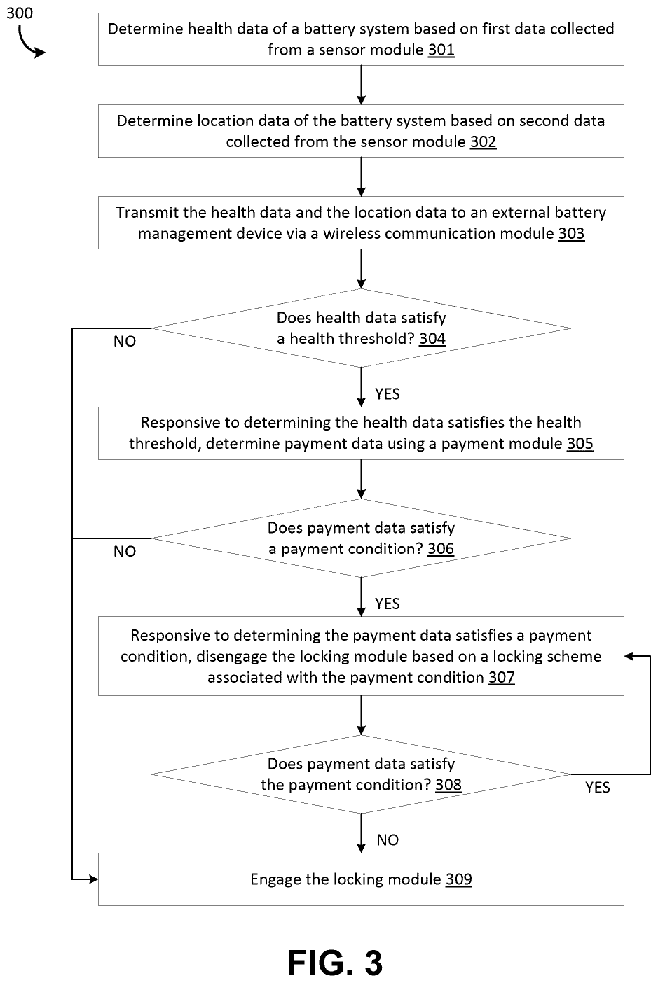

FIG. 3 is a flow diagram of an example method 300 for operating a battery system, in accordance with aspects of the disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. Although illustrated in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 301, processing logic performing the method 300 determines health data of a battery system based on first data collected by the sensor module. In some implementations, the processing logic can provide an indication of the health data to a user interface of the battery system.

At operation 302, processing logic determines location data of the battery system based on second data collected from the sensor module. In some implementations, the processing logic can provide an indication of the location data to a user interface of the battery system. In some implementations, the processing logic can provide location metadata to the user interface. For example, the processing logic can provide location-based weather data to the user interface of the battery system. In some implementations, the sensor module can include one or more of a global positioning system (GPS) module, an accelerometer module, or a gyroscope module.

At operation 303, processing logic transmits the health data and the location data to an external battery management device via a wireless communication module. The external battery management device can connect to multiple battery systems. In some implementations, the connection to the wireless communication module can be a cellular connection. In at least one implementation, the connection to the external battery management device can be facilitated by a pre-paid subscriber identity module (SIM) card associated with a third-party payment provider. In some implementations, the wireless communication module can couple to a user device to. The user device can connect to the external battery management device (e.g., connect to a service through a mobile application, a webpage, etc.) to transmit the health data and/or the location data.

At operation 304, processing logic determines whether health data satisfies a health threshold. The health data can indicate a charge state of the battery system (e.g., 90% charged, 20% charged, 10 kWhs available, 3 kWhs available, etc.). In some implementations, the health threshold can reflect a reserve charge quantity or charge percentage of the battery system. In some implementations, the reserve charge quantity can be separate from a usable charge quantity of the battery system. That is, a system might have, for example, an 11 kWh total capacity, with a usable 10 kWh capacity and a 1 kWh capacity reserve. In some implementations, the reserve capacity can be used to power the components of the battery system, such as the wireless communication module, the sensor module, location tracking sensors or modules, etc.

In some implementations, the health data can additionally or alternatively indicate a battery cell health. That is, whether battery cells managed by the BMS are performing as expected. Battery cells of the battery system might not perform as expected due to exposure to elements, excessive heat, electrical faults, physical damage to the battery cells or battery system, or other similar damage.

At operation 305, responsive to determining the health data satisfies the health threshold, processing logic determines payment data using a payment module. In some implementations, the payment module includes a removably coupled subscriber identity module (SIM) card port. A SIM card coupled to the SIM card port can enable the payment module to contact a third-party payment provider associated with the SIM card, and determine whether a payment has been made to an account associated with the SIM card. Responsive to determining that payment has been made to the account with the SIM card, the processing logic can indicate that the payment data satisfies the payment condition.

In some implementations, the processing logic can provide one or more payment instructions to satisfy the payment condition associated with the locking scheme to a user interface of the battery system. Responsive to determining the payment data satisfies the payment condition, processing logic can provide an indication of the locking scheme to the user interface.

In some implementations, the processing logic can cause the battery system to connect to a user device via the wireless communication module and provide a payment option associated with the payment condition to a user interface of the user device. Responsive to determining the payment option has been selected, processing logic can determine whether the payment data satisfies the payment condition.

At operation 306, processing logic determines whether payment data satisfies a payment condition. In some implementations, the payment module can be configured to directly communicate with a digital payment verification service, such as a third-party payment provider. In some implementations, the payment module can have a dedicated communication module that is separate from the wireless communication module. That is, the payment module can verify payment data via a dedicated communication module, and a battery system controller can use the wireless communication module to communicate collected data about the battery system (e.g., charge status, health data, location data, etc.) to an external battery system management device and/or a user device.

At operation 307, responsive to determining the payment data satisfies a payment condition, processing logic disengages the locking module based on a locking scheme associated with the payment condition. In some implementations, the locking module can be a physical breaker switch that is electronically switched on and off. In some implementations, the locking module can be a digital switch that prevents power from flowing out of the battery system when engaged. In some implementations, to engage the locking module, processing logic causes a power output port of the battery system to decouple from the BMS of the battery system. In some implementations, to disengage the locking module, processing logic causes the power output port of the battery system to couple to the BMS of the battery system.

At operation 308, processing logic determines whether payment data satisfies the payment condition. In some implementations, the payment data and payment condition are associated with a locking scheme. The locking scheme can indicate a schedule for engaging the locking module and disengaging the locking module. In some implementations, the schedule can be based on a kWh usage. For example, a locking scheme can have a schedule to disengage the locking module for 1 kWh of battery usage, and then engage (e.g., reengage) the locking module after the 1 kWh has been used. In some implementations, the schedule can be based on a timed usage. For example, a locking scheme can have a schedule to disengage the locking module for 1 hour of battery usage, and then engage (e.g., reengage) the locking module after the 1 hour expires.

At operation 309, responsive to determining the health data does not satisfy the health threshold, or responsive to determining the payment data does not satisfy the payment condition, processing logic engages the locking module.

What is claimed is:

1. A battery system comprising:
one or more battery cells coupled to a battery management system (BMS);
a power output port;
a wireless communication module;
a payment module, wherein engaging a locking module causes the power output port to decouple from the BMS, and wherein disengaging the locking module causes the power output port to couple to the BMS;
a sensor module; and
one or more processing devices to:
determine health data of the battery system based on first data collected by the sensor module;
determine location data of the battery system based on second data collected by the sensor module;
transmit the health data and the location data to an external battery management device via the wireless communication module;
responsive to determining the health data satisfies a health threshold, determine payment data using the payment module; and
responsive to determining that the payment data satisfies a payment condition, disengage the locking module based on a locking scheme associated with the payment condition.

2. The battery system of claim 1, wherein the payment module comprises a subscriber identity module (SIM) card port, wherein a SIM card is removably coupled to the SIM card port, the one or more processing further to:
contact a third-party payment provider associated with the SIM card;
determine whether a payment has been made to an account associated with the SIM card; and
responsive to determining payment has been made to the account associated with the SIM card, indicate that the payment data satisfies the payment condition.

3. The battery system of claim 2, the one or more processing devices further to:
provide one or more payment instructions to satisfy the payment condition associated with the locking scheme to a user interface of the battery system; and
responsive to determining the payment data satisfies the payment condition, provide an indication of the locking scheme to the user interface.

4. The battery system of claim 1, the one or more processing devices further to:
cause the battery system to connect to a user device via the wireless communication module;
provide a payment option associated with the payment condition to a user interface of the user device; and
responsive to determining the payment option has been selected, determine whether the payment data satisfies the payment condition.

5. The battery system of claim 1, the one or more processing devices further to:
provide an indication of the health data to a user interface of the battery system.

6. The battery system of claim 1, wherein the payment module is configured to directly communicate with a digital payment verification service.

7. The battery system of claim 1, wherein the sensor module comprises one or more of a global positioning system (GPS) module, an accelerometer module, or a gyroscope module.

8. The battery system of claim 1, the one or more processing devices further to:
responsive to determining the health data does not satisfy the health threshold, cause the locking module to engage.

9. The battery system of claim 1, the one or more processing devices further to:
responsive to determining the payment data does not satisfy the payment condition, cause the locking module to engage.

10. A method comprising:
determining health data of a battery system, wherein the battery system comprises:
one or more battery cells coupled to a battery management system (BMS),
a power output port,
a wireless communication module,
a payment module, and
a locking module, wherein engaging the locking module causes the power output port to decouple from the BMS, and wherein disengaging the locking module causes the power output port to coupled to the BMS, and
wherein the health data of the battery system is based on first data collected by the sensor module;
determining location data of the battery system based on second data collected by the sensor module;
transmitting the health data and the location data to an external battery management device via the wireless communication module;
responsive to determining the health data satisfies a health threshold, determining payment data using the payment module; and
responsive to determining that the payment data satisfies a payment condition, disengaging the locking module based on a locking scheme associated with the payment condition.

11. The method of claim 10, wherein the payment module comprises a subscriber identity module (SIM) card port, wherein a SIM card is removably coupled to the SIM card port, the method further comprising:
contacting a third-party payment provider associated with the SIM card;
determining whether a payment has been made to an account associated with the SIM card; and
responsive to determining payment has been made to the account associated with the SIM card, indicating that the payment data satisfies the payment condition.

12. The method of claim 11, further comprising:
providing one or more payment instructions to satisfy the payment condition associated with the locking scheme to a user interface of the battery system; and
responsive to determining the payment data satisfies the payment condition, providing an indication of the locking scheme to the user interface.

13. The method of claim 10, further comprising:
causing the battery system to connect to a user device via the wireless communication module;
providing a payment option associated with the payment condition to a user interface of the user device; and
responsive to determining the payment option has been selected, determining whether the payment data satisfies the payment condition.

14. The method of claim 10, further comprising:
providing an indication of the health data to a user interface of the battery system.

15. The method of claim 10, wherein the payment module is configured to directly communicate with a digital payment verification service.

16. The method of claim 10 wherein the sensor module comprises one or more of a global positioning system (GPS) module, an accelerometer module, or a gyroscope module.

17. The method of claim 10, further comprising:
responsive to determining the health data does not satisfy the health threshold, causing the locking module to engage.

18. The method of claim 10, further comprising:
responsive to determining the payment data does not satisfy the payment condition, causing the locking module to engage.
